(19) United States
(12) Patent Application Publication
(10) Pub. No.: US 2006/0103931 A1
(43) Pub. Date: May 18, 2006

(54) Rear projection screen

(75) Inventors: Kenichi Yakushiji, Niigata (JP); Yuichi Aoki, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/271,552

(22) Filed: Nov. 10, 2005

(30) Foreign Application Priority Data
Nov. 12, 2004 (JP) 2004-329620

(51) Int. Cl. G03B 21/60

(52) U.S. Cl. 359/454

(57) ABSTRACT

There is provided a rear projection screen having a larger viewing angle in a diagonal direction than those in other directions in use. In a fly-eye lens having a plurality of lens units, a lens boundary where lens units adjoin each other has a rectangular shape analogous to an external form of the fly-eye lens and when image light parallel to a direction of an optical axis of the lens unit is incident on a lens face of the lens unit in using the fly-eye lens while orienting a short side of the rectangle in the vertical direction, a diffusion angle of the image light outgoing from the lens unit is larger in a diagonal direction of the rectangle of the external form of the fly-eye lens than those in the horizontal and vertical directions.

### FIELD OF THE INVENTION

The present invention relates to a rear projection screen. More specifically, the invention relates to a rear projection screen having a plurality of lens units arrayed on a plane.

### BACKGROUND ART

Conventionally, with regard to a rear projection screen having a plurality of lens units, there has been known a lens array in which lens units are arrayed in the vertical and horizontal directions at constant pitch as disclosed for example in FIG. 3 in Japanese Patent Application Publication (Laid-Open) No. 1987-259631. JPAP 1987-259631 describes that the pitch in the vertical direction and that in the horizontal direction are different from each other. There has been also proposed a lens array in which a shape of boundary of the lens unit in the direction orthogonal to an optical axis is formed into a rhombus shape to expand horizontal and vertical viewing angles as disclosed in Japanese Patent Application Publication (Laid-Open) No. 2000-131506 for example.

By the way, it is necessary to diffuse image light outgoing from each part of the screen in order to keep luminance of the whole display, seen from a viewer, to a certain level or more. Since an observation angle (an angle formed between a line of sight of the viewer to the screen and a normal line of the screen) from the viewer positioned around a peripheral part of the display becomes large as the size of the display increases, the screen is required to have an enough diffusing performance. However, an immoderate increase of the diffusivity of the screen may lead to a drop of front luminance of the screen. Accordingly, there has been a problem that the screen must have the diffusivity adequately reflecting the screen observation conditions of the viewer.

It is therefore an object of the invention to provide a rear projection screen solving the above-mentioned problem. This object may be achieved through the combination of features described in independent claims of the invention.

Dependent claims thereof specify preferable embodiments of the invention.

### SUMMARY OF THE INVENTION

In order to solve the above-mentioned problem, according to a first aspect of the invention, there is a provided rear projection screen in which a plurality of lens units are arrayed in a plane, whose external form is rectangular and having the following characteristics. That is, a lens boundary where lens units adjoin each other has a rectangular shape analogous to the external form of the rear projection screen and when image light parallel to a direction of an optical axis of the lens unit is incident on a lens surface of the lens unit in using the rear projection screen while orienting a short side of the rectangle in the vertical direction, a diffusion angle of the image light outgoing from the lens unit is larger in a diagonal direction of the rectangle of the rear projection screen than those in the horizontal and vertical directions. This make it possible to provide images whose corners on the rear projection screen are not darkened to viewers.

In the rear projection screen described above, curvature of the lens unit may be constant in a rotation direction centering on the optical axis. It facilitates designing and production of the lens unit.

In the rear projection screen described above, the diffusion angle of the image light outgoing from the lens unit is larger in the horizontal direction than that in the vertical direction when the image light parallel with the direction of the optical axis of the lens unit is incident on the lens face of the lens unit in using while orienting the short side of the rectangle of the rear projection screen in the vertical direction. It increases the viewing angle in the horizontal direction more than the viewing angle in the vertical direction, allowing a good viewing angle characteristic as a rear projection screen.

It is noted that the summary of the invention described above does not necessarily describe all the necessary features of the invention. The invention may also be a sub-combination of the features described above.

### BRIEF DESCRIPTION OF DRAWINGS

FIG. 1 is a diagram showing a structure of a rear projection display according to one embodiment of the invention.

FIG. 2 is a section view showing a structure of a screen.

FIG. 3 is a plan view showing an external form of a fly-eye lens and a shape of boundary of a lens unit.

FIG. 4 is a perspective view showing an external form of the lens unit.

FIG. 5 shows routes of image light respectively in the vertical, horizontal and diagonal directions of the lens unit.

FIG. 6 is a graph showing a luminance distribution with respect to an observation angle in the diagonal direction of the fly-eye lens.

FIG. 7 is a graph showing a luminance distribution with respect to an observation angle in the horizontal direction of the fly-eye lens.

FIG. 8 is a graph showing a luminance distribution with respect to an observation angle in the vertical direction of the fly-eye lens.

FIG. 9 is a drawing showing a relationship between position of a viewer with respect to the screen and the observation angle.

### DETAILED DESCRIPTION OF THE INVENTION

The invention will now be described based on preferred embodiments while showing operations of the invention based on the drawings, which do not intend to limit the scope of the invention, but exemplify the invention. All of the features and the combinations thereof described in the embodiments are not necessarily essential to the invention.

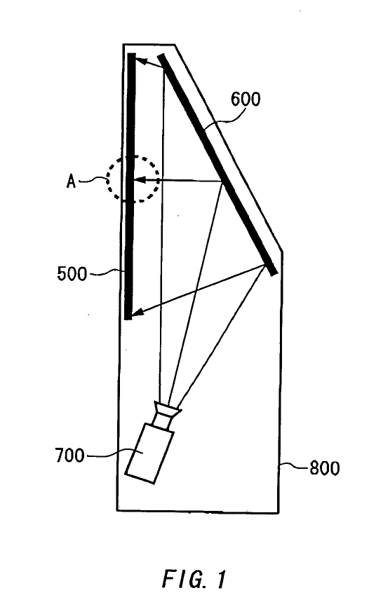

FIG. 1 shows a structure of a rear projection display 800 according to one embodiment of the invention. The rear projection display 800 has an optical engine 700, a mirror 600 and a screen 500. An optical image outputted from the optical engine 700 is reflected by the mirror 600 and is inputted to the screen 500. The screen 500 realizes an adequate observation area by diffusing the incident optical image and outputting it to the viewer side.

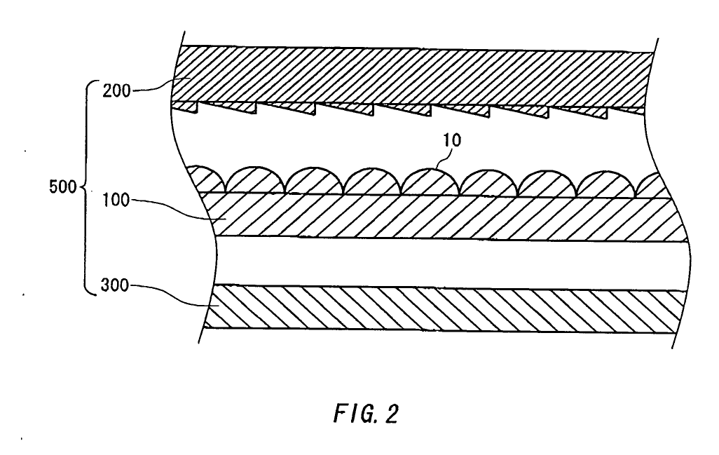

FIG. 2 shows a detailed structure of a part A in the screen 500 in FIG. 1. The screen 500 has a Fresnel lens 200, a fly-eye lens 100 and a protective plate 300. The Fresnel lens 200 adjusts an advancing direction of the light outputted from the optical engine 700 in the direction of an optical axis of the fly-eye lens 100. The fly-eye lens 100 has a plurality of lens units 10 and diffuses and outputs the incident light by the lens units 10. The protective plate 300 protects the fly-eye lens 100 and reduces reflection of external light by means of anti-glare processing such as AR coating applied on the surface thereof. The fly-eye lens 100 is one example of the rear projection screen in the present invention.

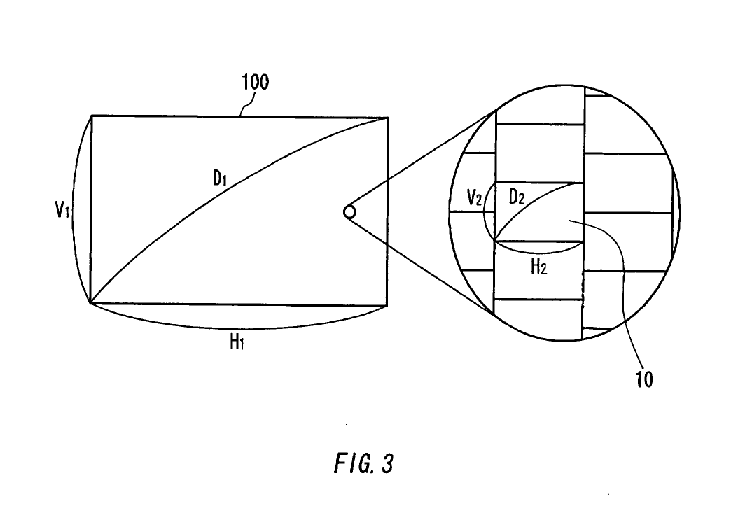

FIG. 3 is a plan view showing an external form of the fly-eye lens 100 and a shape of boundary of the lens units 10. The shape of boundary of the lens unit 10 is rectangular analogous to the external form of the fly-eye lens 100 and has the same orientation with the external form of the fly-eye lens 100. For instance, assume that the vertical direction of the fly-eye lens 100, i.e., a length thereof in the vertical direction in use, is V₁, the transverse direction thereof, i.e., a length thereof in the horizontal direction in use, is H₁, a length of the lens unit 10 in the boundary shape is V₂ and a length of the lens unit 10 in the horizontal direction in the boundary shape is H₂. Still more, assume that a distance of a diagonal line of the fly-eye lens 100 is D₁ and a distance of a diagonal line of the lens unit 10 is D₂. In this case, the following relationship holds:
V₁:H₁:Dₗ=V₂:H₂:D₂
D₁>H₁, D₁>V₁, D₂>H₂, D₂>V₂
   Still more, the direction of the diagonal line of the lens unit 10 coincides with the direction of the diagonal line of the fly-eye lens 100. Accordingly, a length of a ridge line of the lens unit 10 is maximized in the direction of the diagonal line of the fly-eye lens 100.

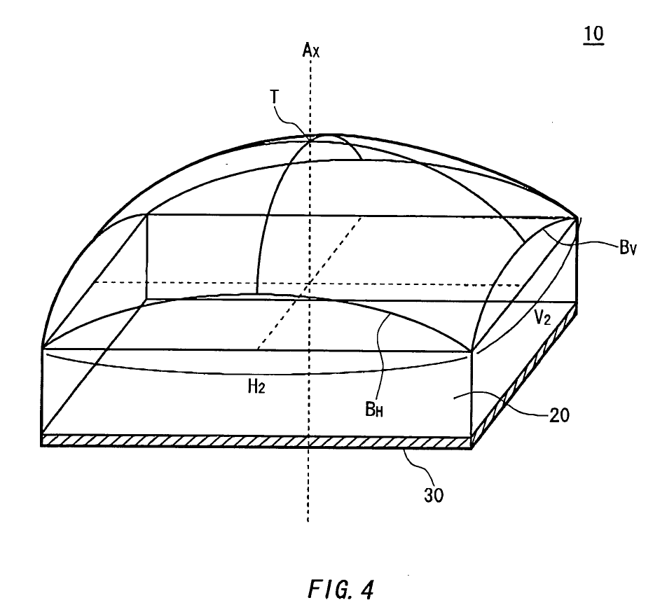

FIG. 4 is a perspective view showing an external form of the lens unit 10. In the figure, Ax denotes the optical axis of the lens unit 10 and T denotes an apex of the lens unit 10. Still more, B_{V} denotes a boundary line of the lens unit 10 extending in the vertical direction in using the fly-eye lens 100 and B_{H} denotes a boundary line of the lens unit 10 extending in the horizontal direction. The both lines B_{V} and B_{H} are arched and meet at the diagonal parts shown in FIG. 3. Curvature of the lens unit 10 of the present embodiment is constant in the rotation direction centering on the optical axis Ax.

A distance from the apex T of the lens in the direction of the optical axis Ax of the lens unit 10 to the lens boundaries B_{V} and B_{H} is maximized in the diagonal direction of the rectangle shown in FIG. 3. That is, with respect to the direction of the optical axis Ax, the distance from the apex T to the lens boundary in a section of the lens in the diagonal direction passing through the optical axis Ax is larger than the distance from the apex T to the lens boundary B_{V} in a section of the lens in the horizontal direction passing through the optical axis Ax. Similarly to that, with respect to the direction of the optical axis Ax, the distance from the apex T to the lens boundary in the section of the lens in the diagonal direction passing through the optical axis Ax is larger than the distance from the apex T to the boundary B_{H} in a section of the lens in the vertical direction passing through the optical axis Ax.

The distances from the apex T to the boundaries B_{V} and B_{H} in the horizontal direction of the lens unit 10 in terms of the direction of the optical axis Ax thereof are larger than those in the vertical direction of the lens unit 10. That is, the distance from the apex T to the boundary B_{V} in terms of the direction of the optical axis Ax is larger than the distance from the apex T to the boundary B_{H} in terms of the direction of the optical axis Ax. Accordingly, when image light parallel to direction of the optical axis of the lens unit 10 is incident on the lens face of the lens unit 10 in using while orienting a short edge of the rectangle of the fly-eye lens 100 in the vertical direction, a diffusion angle of the image light outgoing from the lens unit 10 becomes larger in the diagonal direction of the rectangle of the fly-eye lens 100 than those in the horizontal and vertical directions. This make it possible to provide images in which corners on the screen 500 are not darkened to the viewer.

As a material of the lens unit 10, a material whose refractive index is approximately 1.4 to 1.65 is used among materials transmitting at least visual light, so that the lens unit 10 has the refractive index of substantially from 1.4 to 1.65. When a material whose refractive index is smaller than 1.4 is used, the lens unit 10 may not have enough lens power and is unable to diffuse the incident light at adequate angle. When a material whose refractive index is larger than 1.65 is used in contrary, light incident on the lens unit 10 reflects internally and transmissivity drops as a screen. Because there are many materials whose refractive index is 1.4 to 1.65 among plastics and glass, the material of the lens unit 10 may be selected corresponding to a manufacturing method and material cost. It is noted when a material whose refractive index is 1.4 or 1.65 is selected, the refractive index may fall under 1.4 or may exceed 1.65 depending on variation of characteristics of the material. However, such variation falls within an allowance of the present embodiment. While a degree of variation of characteristics of the material may vary depending on the type of the material and on makers of the material, it is around 1.4±0.05 and 1.65±0.05.

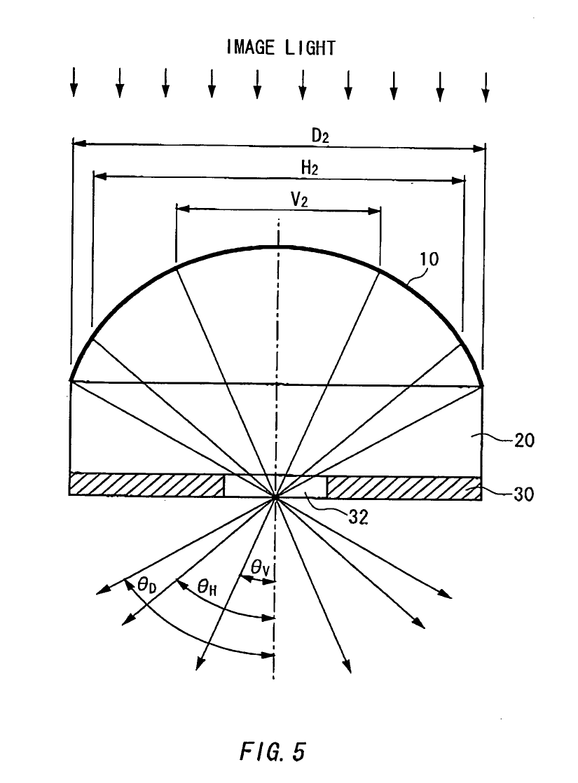

FIG. 5 shows routes of the image light respectively in the vertical, horizontal and diagonal directions of the lens unit 10. In the figure, V₂ denotes the length of the lens unit 10 in the vertical direction, H₂ denotes the length of the lens unit 10 in the horizontal direction and D₂ denotes the length of the lens unit 10 in the diagonal direction. The lens unit 10 is fixed on a substrate 20 made from resin. The substrate 20 has a thickness reaching to the vicinity of a focal point of the lens unit 10. A black matrix 30 is provided on the substrate 20 on the opposite side from the lens unit 10. The black matrix 30 absorbs light. The black matrix 30 has an opening 32 formed centering on the optical axis of the lens unit 10 so as to have a smallest possible size for transmitting the image light. The image light incident on the lens face of the lens unit 10 almost in parallel with the optical axis of the lens unit 10 refracts at an angle corresponding to the shape of lens of the incident surface, is converged at the focal point on the optical axis of the lens unit 10 and is then diffused and outputted from the opening 32. That is, the black matrix 30 selectively outputs the image light and prevents reflection of external light. Thereby, the screen 500 can show images having high contrast to the viewer side.

The image light incident in the range of D₂ in the diagonal direction of the lens unit 10 goes out of the opening 32 with a diffusion angle of θ_{D}. The image light incident in the range of H₂ in the horizontal direction of the lens unit 10 goes out of the opening 32 with a diffusion angle of θ_{H}. Similarly to that, the image light incident in the range of V₂ in the vertical direction of the lens unit 10 goes out of the opening 32 with a diffusion angle of θ_{V}. The distance D₂ in the diagonal direction of the lens unit 10 is larger than either one of the distance H₂ in the horizontal direction and the distance V₂ in the vertical direction as described above. Accordingly, as it is apparent from the figure, the diffusion angle θ_{D} in the diagonal direction is larger than either one of the diffusion angle θ_{H} in the horizontal direction and the diffusion angle θ_{V} in the vertical direction. Thereby, an viewing angle of the image light outgoing from the fly-eye lens 100 is larger in the diagonal direction of the lens unit 10 than those of the horizontal and vertical directions.

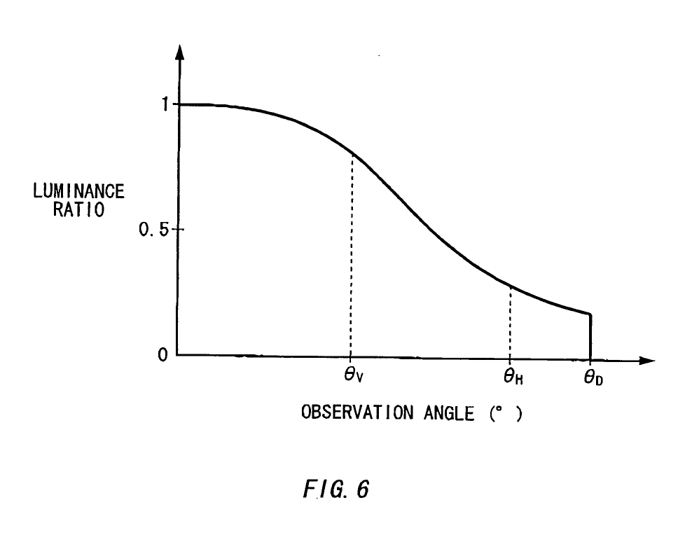

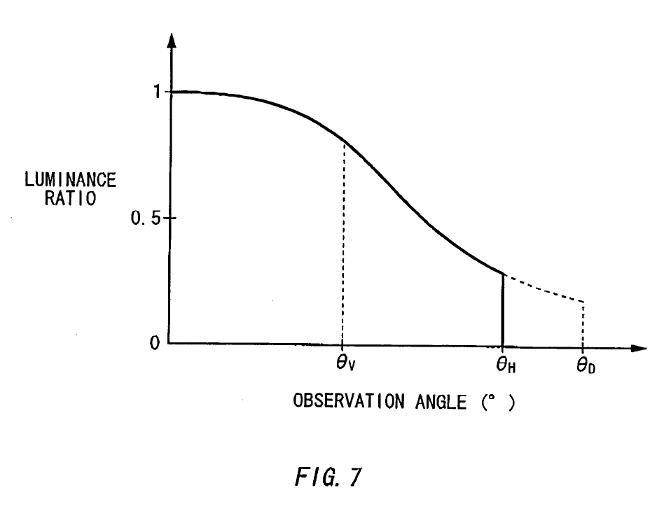

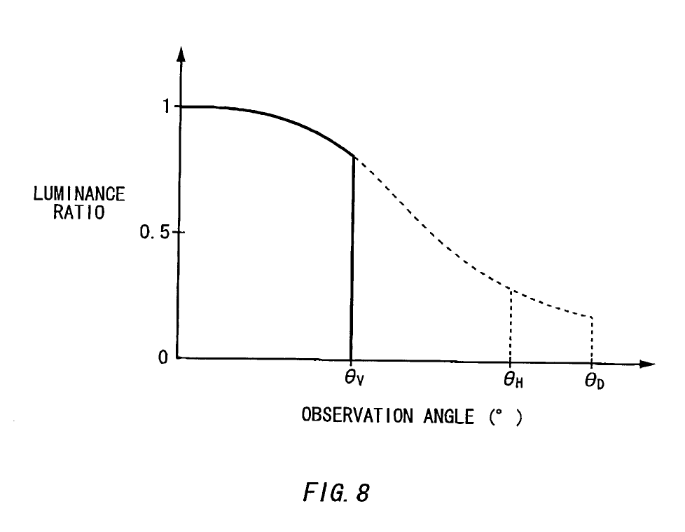

FIGS. 6 through 8 are graphs showing luminance distribution with respect to an observation angle of light outgoing from the fly-eye lens 100. An axis of abscissas represents an inclination of observation angle with respect to the direction of the optical axis. An axis of ordinate represents a ratio of luminance indicating the luminance of the fly-eye lens 100 when the observation angle is 0°, i.e., when the luminance of the lens unit 10 in observing the output side thereof from the direction of the optical axis is set at 1. The luminance of the fly-eye lens 100 decreases monotonously as the observation angle increases. FIGS. 7 and 8 show changes of the luminance when the observation direction is inclined in the horizontal and vertical directions of the fly-eye lens 100, respectively. When the observation direction is inclined in the horizontal and vertical directions, respectively, the luminance sharply drops at the moment when the diffusion angle reaches respectively to the diffusion angles θ_{H} and θ_{V} explained in FIG. 5. Meanwhile, FIG. 6 shows changes of the luminance when the observation angle is inclined in the diagonal direction of the fly-eye lens 100. When the observation direction is inclined in the diagonal direction, the luminance does not drop sharply until the diffusion angle reaches to the diffusion angle θ_{D} that is larger than either one of the diffusion angles θ_{H} and θ_{V}.

According to another embodiment, the shape of the lens unit 10 may be changed in the rotation direction centering on the optical axis Ax. That is, the lens unit 10 may be an irrotational axis symmetric lens. In this case, the lens power of the lens unit 10 in the horizontal direction in use is desirable to be larger than the lens power thereof in the vertical direction in use. It increases the viewing angle in the horizontal direction more than that in the vertical direction, allowing a good viewing angle characteristic as the screen 500. It is noted that the lens power indicates power of lens for refracting light and is dependent on a shape of the lens and on a refractive index of lens material.

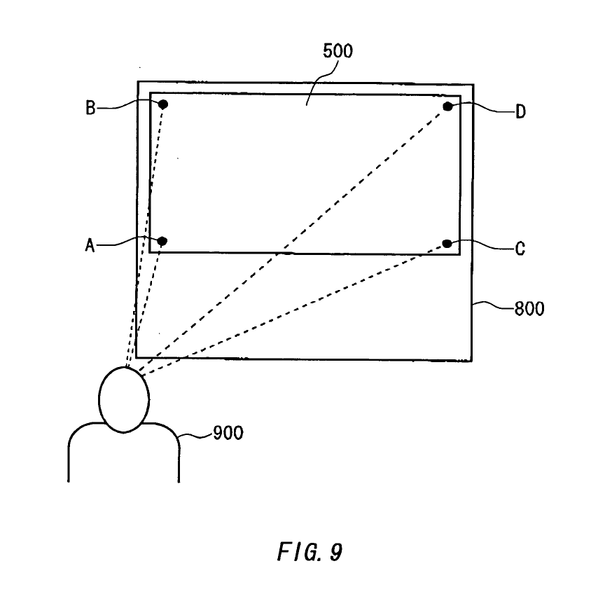

FIG. 9 shows one exemplary relationship between position of a viewer 900 with respect to the screen 500 of the embodiment and the observation angle. Assuming that the viewer 900 observes the screen 500 from some position in front of the screen 500, the observation angle is maximized when the viewer 900 observes diagonal corners from the position in front of a corner of the screen 500. For instance, the observation angle is maximized when the viewer 900 observes the diagonal corner D from the position in front of the lower left corner A of the screen 500. In this case, the observation angle in observing the diagonal corner D is larger than the observation angles in observing the corner B located above the corner A and the corner C located on the right side of the corner A. Even under such observation condition, the viewing angle of the fly-eye lens 100 of the present embodiment is larger in the diagonal direction of the screen 500 than that of the conventional fly-eye lens in which the boundary of lens seen from the direction of optical axis is not analogous with the external form of the screen. Accordingly, it is capable of providing images in which the corners on the screen 500 are not darkened to the viewer 900.

As it is apparent from the above description, the fly-eye lens 100 of the present embodiment has the larger viewing angle in the diagonal direction of the screen 500 in use than those in the other directions. It is capable of enlarging the viewing angle in the diagonal direction in which the observation angle is apt to increase especially in a large size screen of 50 inches or more.

It is noted that the shape of the lens is desirable to be convex to the outside to the boundary of the adjacent lens unit 10 in order to maximize the lens effective part of the lens unit 10 in the fly-eye lens 100. However, because the boundary of the lens unit 10 becomes a sharp edge in this case, a crack is apt to be generated from the edge in manufacturing or assembling the lens. Accordingly, the boundary of the lens unit 10 may be linked by a corner R in order to assure the strength of the lens boundary. In this case, the size of the corner R of the lens boundary part is appropriate to be 1/10 or less of the pitch of the lens unit 10.

A manufacturing method of the fly-eye lens 100 will be explained below. The material of the lens may be any material as long as it transmits at least visual light and whose refractive index falls within the range of about 1.4 to 1.65. For instance, it may be known thermosetting resin, light-curable resin, thermoplastic resin, glass and others. That is, the method may be of molding the lens by filling the resin into a mold in which the shape of the lens described above is marked or of transferring the material filled in the mold to a substrate. Still more, the method may be of coating the light curable resin such as UV curable resin evenly on the substrate, irradiating rays to regions where the lenses are formed to cure and then removing unnecessary part, of creating the shape of the lens by mechanically cutting the surface of the substrate or of combining those methods,

Among them, the method of molding the lens by filling the lens material between the mold and the substrate is preferable because it allows the lens unit 10 to be manufactured most effectively and accurately. That is, as shown in FIG. 4, a substrate 20, which is a transparent plastic film, is sandwiched between the lens unit 10 and the black matrix 30 on the opposite side from the lens face.

It is noted that as the method for manufacturing the mold, mechanically cutting, etching of glass on which partial masking is implemented, photolithographic technique, MEMS (microelectromechanical system) and the like are known and any means may be employed. While the mold may be of plate-like one in this case, it is specifically preferable to use a mold of roll-to-roll system when the substrate 20 is a flexible plastic film or the like. The mold of roll-to-roll system allows the lens units 10 to be manufactured continuously across a wide area by using the flexible substrate 20. It then allows the fly-eye lens 100 to be manufactured effectively.

Still more, a method including the steps of laminating a curing energy ray curable resin such as UV curable resin, curing desired parts by selectively irradiating the curing energy ray such as UV and then removing non-cured parts may be used.

The light curable resin is most preferable as the lens material from the points of view of its productivity, accuracy of its shape and simplicity of equipment. When the substrate 20 is a thin plastic film in particular, it is preferable to use the light curable resin, e.g., the UV curable resin in particular, which is cured by rays, as the lens material in terms of curability, flexibility and flexuosity. Characteristics of the light curable resin may be modified by changing components of the light curable resin such as monomer, prepolymer, polymer, photopolymerization initiator and others.

The monomer and prepolymer preferably used as one of the components composing the light curable resin have basically at least one or more functional group. When the reacting curing energy ray is UV, it is necessary to add a substance that generates ions or radicals when the curing energy ray is irradiated, i.e., the so-called photopolymerization initiator, beside the main components.

Here, the functional group such as vinyl group, carboxyl group, hydroxyl group and the like is an atomic group or a bonding pattern that causes reaction. Monomer and prepolymer that have the vinyl group such as acryloyl group is preferably used from the aspect of its curableness in the present embodiment from the point of curing the resin component by irradiating the curing energy rays.

Such monomer having the acryloyl group may be adequately selected and used from heretofore known monomers and is not specifically limited. Typically, they may be heretofore known monomers of monofunctional group such as 2-ethyl hexyl acrylate, 2-hydroxy ethyl acrylate, 2-hydroxy propyl acrylate, acrylate of tetrahydrofuryl and its derivatives, heretofore known monomers of bifunctional group such as dicyclopentenyl acrylate, 1,3-butadiol diacrylate, 1,4-butadiol diacrylate, 1,6-hexadiol diacrylate, diethylenegrycol diacrylate, polyethylene glycol diacrylate, tripropylene glycol diacrylate and dimethyloltricyclodecan diacrylate, and heretofore known monomers of trifunctional group or more such as trimethylolpropane triacrylate, pentaerythritol triacrylate and dipentaerythritol hexaacrylate. Among the monomers described above, heretofore known monomers in the trifunctional group or less are preferably used from the aspects of that they excel in the flexibility because their film hardness after curing becomes HB or less, that their cross-linking density is small and their volumetric shrinkage rate is low and that they have excellent curl resistance.

Beside the monomers described above, prepolymer is often used together with the monomers in the present embodiment. The prepolymer used in the present embodiment is not specifically limited as well as the monomer. Typically, they may be polyester acrylate, epoxy acrylate and urethane acrylate and prepolymers of trifunctional groups or less, or preferably prepolymers of bifunctionalal group or of trifunctional group, is used from the aspect of low volumetric shrinkage and flexibility.

The photopolymerization initiator is not also specifically limited and typically, they may be carbonyl compounds such as acetophenone, benzophenone, Michler's ketone, benzil, benzoin, benzoinether, benzyl dimethyl ketal, benzoinbenzoate and α-acyloxym ester compounds, sulfur compounds such as tetramethyl thiram monosulfide, thioxanethone group compounds, and phosphorus series such as 2, 4, 6-trimethyl benzoil diphenylphosfine oxide. These are used singularly or by mixing two or more.

A doping amount of the photopolymerization initiator is 0.1 to 20 parts per hundred parts of the monomer and/or prepolymer (phr), or more preferably to be 0.5 to 15 phr. When the ratio of the photopolymerization initiator is below the range described above, the curability becomes low and when it exceeds the range, the agent bleeds out after curing. Accordingly, it is preferable to set the ratio within the range in order not to cause such problems.

Still more, various additives may be used to control characteristics and properties of the resin components before, during and after curing or characteristics and properties of the cured film in the present embodiment. Here, as a substance for controlling the characteristics and properties of the resin before curing, there are coating stabilizer (antigelling agent, anticuring agent), thickeners (for improving applicability) and others. Still more, as a substance for controlling the characteristics of the resin during curing, there are photopolymerization accelerator, light absorbing agent (both for adjusting behavior of curing) and others. Furthermore, as a substance for controlling the film characteristics after curing, there are plasticizer (for improving flexibility) and UV absorbing agent (for giving lightfastness).

Polymer may be added to the light curable resin used in the present embodiment from the aspect of strength, flexibility and curing resistance. Here, the type of the polymer is not specifically limited and known polymer such as polyester resin, acrylic resin, urethane resin, epoxy resin and the like may be used. Chlorinated polymer may be used when decay durability and adhesiveness are taken into account. The chlorinated polymer may be categorized into two types of polymer of monomers containing chlorine and so-called post-chlorination product obtained by chlorinating various polymers. As examples of the polymer of monomers containing chlorine, there are polyvinyl chloride and its copolymer, polyvinylidene chloride and its copolymer and chloroprene rubber. As examples of the post-chlorination product, there are chlorinated polypropylene, chlorinated polyethylene, chlorinated polyester, chlorinated rubber and chlorinated polyisoprene. Preferably, the post-chlorination product is used in the present embodiment.

Although the method for chlorinating the polymer is not specifically limited, the simplest method is to manufacture it through steps of dissolving the rubber or polymer into a chlorinated solvent such as carbon tetrachloride and chloroform, of chlorinating it in 40 to 90 degrees and distilling, cleaning and drying it. The content of the chlorinated polymer is 10 to 100 phr, or preferably 20 to 60 phr. It is not preferable for the content to be below the range described above because the effect of addition is low and to exceed the range because photosensitivity of the light curable resin drops.

Preferably, a plastic sheet or plastic film is used for the substrate 20 provided between the lens unit 10 and the black matrix 30 in the present embodiment. The material of the substrate 20 may be acrylic resin, methacrylic resin, polystyrene, polyester, polyolefin, polyamide, polycarbonate and polyether. Or, it may be polyimide, polyetherimide, polyamideimide, polyethersulfone, maleimide resin, polyvinyl chloride, polyacrylic ester or polymetha acrylic acid ester, melamine resin, triacetil cellulose resin and norbornene resin. Although their copolymers, blends or cross-linked materials may be also used, biaxially-oriented polyethylene telephthalate film is preferable among the polyester films from a point of balance of its optical characteristics such as transparency and mechanical strength.

The manufacturing method of the fly-eye lens 100 described above is suitable to a fly-eye lens whose converging distance is relatively small as compared to an array pitch such that a pitch of the lens unit 10 is 200 μm or less and the converging distance is 200 μm or less. Specifically, it is suitable for accurately and stably manufacturing a fly-eye lens sheet wherein the pitch of the lens unit 10 is 100 μm or less and the converging distance is smaller than the array pitch.

A known self-alignment method is used as a method for forming the openings 32 in the black matrix 30. Parallelism of the energy rays to be irradiated to the lens unit 10 and uniformity within the fly-eye lens face may be selected variously from the characteristics of the fly-eye lens sheet to be found. An intensity distribution of the energy rays corresponding to the array pattern of the lens unit may be obtained by using energy rays having a parallelism of 6 degrees or less indicated in terms of full width at half maximum. Still more, in terms of the uniformity, a minimum value of the intensity of irradiation at arbitrary nine points within the irradiated plane to a maximum value thereof is preferable to be 80% or more.

In the self-alignment method described above, the optical path of the energy ray such as UV to be irradiated deviates from the optical path of visual light in actual use due to a refractive index wavelength dependence of the lens unit 10 and the substrate 20. Then, as means for correcting this deviation, the UV to be used for exposure may be diffused at a certain angle in advance, exposure may be carried out while rocking an optical axis of exposure light within a range of ±10 degrees from the optical axis of the lens unit 10, or these may be carried out at the same time. Concretely, a photosensitive resin component (hereinafter referred to as a positive type photosensitive resin in some cases) whose solubility to solvent rises due to the energy rays is coated on the lens unit 10 on the opposite side from the lens face and is exposed by light from the lens face to selectively dissolve and remove the photosensitive parts and to form the black matrix 30 in which the pattern of the openings 32 is formed. In this case, preferably a method of coating the positive type resin component having a light blocking effect on the lens unit 10 on the opposite side from the lens face and irradiating the energy rays parallel with the optical axis of the lens unit 10 from the lens face to dissolve and remove parts other than object parts by utilizing the light converging effect of the lens is used.

It is preferable to increase contrast of intensity distribution of exposure light in order to accurately form the array pattern of the black matrix 30. Accordingly, the black matrix 30 must be positioned at the position of focal point determined by the lens shape of the lens unit 10. A distance between the lens unit 10 and the black matrix 30 may be readily and accurately controlled by adjusting the thickness of the substrate 20 provided between the lens unit 10 and the black matrix 30 in the present embodiment. Accordingly, the array pattern of the openings 32 may be readily and accurately formed.

It is noted that the black matrix 30 is constructed by known materials such as the resin component described above to which metal and its oxide, pigment or dye is added. Among them, the resin component to which the pigment or dye is added is preferable because it absorbs external light that may cause noise. Tone of the black matrix 30 is preferable to be black to visual light. For instance, it is preferable to use the resin component into which pigments such as carbon black and titanium black or black dye is dispersed or dissolved. Still more, when dye is used, it is preferable to use black dye whose fastness to sunlight is 5 or more from the aspect of lightfastness and others and it is most preferable to use azo black dye from the aspects of dispersibility, compatibility with the resin and general versatility. Still more, a resin component used to disperse or dissolve the pigment or dye described above may be known resins such as acrylic resin, urethane resin, polyester, novolac resin, polyimide and epoxy resin.

Although the invention has been described by way of the exemplary embodiments, the technological scope of the embodiment of the invention is not limited to the scope of the embodiment described above. It should be understood that those skilled in the art might make many changes and substitutions without departing from the spirit and scope of the invention. It is obvious from the definition of the appended claims that the embodiments with such modifications also belong to the scope of the invention.

What is claimed is:

1. A rear projection screen having a plurality of lens units arrayed in a plane and having a rectangular external form, wherein
a lens boundary where the lens units adjoin each other has a rectangular shape analogous to the external form of said rear projection screen; and
when image light parallel to a direction of optical axis of said lens unit is incident on a lens face of said lens unit in using said rear projection screen while orienting a short side of said rectangle in the vertical direction, a diffusion angle of said image light outgoing from said lens unit is larger in a diagonal direction of said rectangle of said rear projection screen than those in the horizontal and vertical directions.

2. The rear projection screen as set forth in claim 1, wherein curvature of said lens unit is constant in a rotation direction centering on the optical axis.

3. The rear projection screen as set forth in claim 1, wherein the diffusion angle of said image light outgoing from said lens unit is larger in the horizontal direction than that in the vertical direction when said image light parallel with the direction of the optical axis of said lens unit is incident on the lens face of said lens unit in using while orienting the short side of said rectangle of said rear projection screen in the vertical direction.

4. The rear projection screen as set forth in claim 1, wherein the lens unit has the refractive index from substantially 1.4 to 1.65.
